(19) United States
(12) Patent Application Publication
(10) Pub. No.: US 2010/0312655 A1
(43) Pub. Date: Dec. 9, 2010

(54) SYSTEM AND METHOD FOR ADVERTISING AND SELLING PUBLISHED MATERIAL USING SOCIAL AND COMPUTER NETWORKS

(76) Inventor: Bernard Farkas, Herndon, VA (US)

Correspondence Address: HYRA IP, PLC, 11710 Plaza America Drive, Suite 2000, Reston, VA, 20190, US

(21) Appl. No.: 12/795,234

(22) Filed: Jun. 7, 2010

Related U.S. Application Data
(60) Provisional application No. 61/185,394, filed on Jun. 9, 2009.

(51) Int. Cl. G06Q 30/00; G06F 15/16

(52) U.S. Cl. 705/14.73; 705/14.4; 709/206

(57) ABSTRACT

A series of text message units are created that follow the storyline of a fiction work, or in the case of a non-fiction work, a theme, philosophy, or set of facts. These message units are released into various social and/or computer networks in a periodic sequence and can be viewed freely by any network member, thus creating interest in the work. A database of all previously released message units can be retrieved from the host website by a computer to computer transfer. The host website has the capability to act as a store and sell selected chapters of the final published work by virtue of computer to computer transfers. Further, the host store can sell the entire published work in a variety of methods including computer to computer downloads, or by delivery of tangible products such as print, portable computer readable memory elements or audio copies.

This application claims the benefit of U.S. Provisional Applications No. 61/185,394, filed Jun. 9, 2009, which is hereby incorporated by reference in its entirety.

### BACKGROUND OF THE INVENTION

The business of distributing fiction, non-fiction, and biographical stories is rapidly being limited because of ever increasing distribution and sales costs. As a consequence many excellent intellectual products are denied access to mass distribution outlets and are severely limited in their ability to reach their true audience potential. Accordingly, the publishing industry is losing revenue and the public is denied access to many valuable and entertaining intellectual achievements.

Needs exist for improved methods of advertising and selling stories to their intended audiences.

### SUMMARY

It is to be understood that both the following summary and the detailed description are exemplary and explanatory and are intended to provide further explanation of the invention as claimed. Neither the summary nor the description that follows in intended to define or limit the scope of the invention to the particular features mentioned in the summary or in the description.

In certain embodiments, the disclosed embodiments may include one or more of the features described herein.

“Computer network” as used herein encompasses any network of processor-based or computing devices, including tablet and other portable computers, PDAs, smart phones, cell phones, servers and electronic terminals of all kinds.

Opportunities to lower costs and increase the efficiency of advertising and selling books to their intended audiences are becoming more feasible as computer networking technological developments keep advancing, and more particularly as social networking increases in popularity and usage. The method embodied in this invention is made possible because of these new advancements and the growing popularity of social networking in particular, and computer networking in general.

In a new method of advertising stories, a series of short, plain text message units are created that follow the storyline and chapter layout of a published work. These message units are released by a host website into various social and/or computer networks on a set periodic sequence, hourly, daily or weekly, and can be viewed freely and for no cost by any network member, thus creating interest in the published work. Further, a data base of all previously released message units can be reviewed and/or retrieved by any network member at any time from the host website for no cost by a computer to computer connection.

The host website has the capability to act as a store and sell selected chapters of the final published work as well as the entire work, to network members or to other persons, by virtue of computer to computer transfers. The entire work in some embodiments is sold through the website by electronic download or physical fulfillment, and the price of a chapter is in some embodiments nominal and typically less than for the full work.

This method results in the creation of a plurality of segments made up of one or two short sentences which follow a prescribed sequence, herein after referred to as a “Bookclipz Story”, organized in a manner that parallels a full blown novel (or another type of intellectual property work). This type of document is not now created in the world of book publishing or in other allied fields, and can be a very important instrument in the book selling process and in selling other types of intellectual property. Book sales methods that are presently used include testimonial statements, extolling the reputation of the author, book signings by the author, TV appearances by the author, best selling lists, and critic reviews, to name the best of the presently used methods. These techniques work, but they are expensive and very limiting to the beginning author or small publisher.

The Bookclipz Story method entails, but is not limited to, the creation and distribution of the Bookclipz Story. The method works because of the Internet. Social networks are good sales targets because they present a viral, built-in audience. But, social networks are not the only way to deliver the Bookclipz story to potential audiences. For example, associations, schools, clubs, and business organizations provide other target computer networks that the Bookclipz Story method easily adapts to.

In one embodiment, the same bookclipz concept, with a variation, is used for non-fiction books, by organizing a series of short bursts of sentences with content from a particular non-fiction work. These bursts are limited to 140 characters in some embodiments for tweeting, and are not so limited in other embodiments. These snippets of information are put together in an ordered sequence, and when read together transmit a flow of thoughts, which follows important ideas or themes that are contained in the non-fiction work. This feature allows the user to better sample the work and is instilled the user with a greater confidence to buy the item.

This adaptation of a Bookclipz Story is used to sell a variety of non-fiction works, and a wide variety of other fiction or non-fiction intellectual property items: movies, magazines, audio tapes, patents, seminar reports, newspapers, etc.

The Bookclipz Story method is in some though not necessarily all respects analogous to making a trailer for a movie. It has been working for that market for over 70 years, with great results. The book world has nothing like it, but advances in distribution and communication technology now make possible the comparable but unique method of the Bookclipz Story. By providing tidbits or snippets from a book that parallel the overall story and book layout, titillating insights into the content of the book can be disseminated that go far beyond a table of contents or even a sample chapter.

A “text” refers to any written work such as a novel, book, magazine or scholarly article, etc., as well as spoken-word audio recordings.

These and other objects and features of the invention are apparent in the disclosure, which includes the above and ongoing written specification.

### BRIEF DESCRIPTION OF THE DRAWINGS

The accompanying drawings, which are incorporated herein and form a part of the specification, illustrate exemplary embodiments and, together with the description, further serve to enable a person skilled in the pertinent art to make and use these embodiments and others that will be apparent to those skilled in the art. The invention will be more particularly described in conjunction with the following drawings wherein:

FIG. 1 is a diagram of a text advertisement system.

FIG. 2 is a diagram of a text advertisement system.

### DETAILED DESCRIPTION

A system and method for advertising and selling published material using social and/or computer networks will now be disclosed in terms of various exemplary embodiments. This specification discloses one or more embodiments that incorporate features of the invention. The embodiment(s) described, and references in the specification to “one embodiment”, “an embodiment”, “an example embodiment”, etc., indicate that the embodiment(s) described may include a particular feature, structure, or characteristic. Such phrases are not necessarily referring to the same embodiment. When a particular feature, structure, or characteristic is described in connection with an embodiment, persons skilled in the art may effect such feature, structure, or characteristic in connection with other embodiments whether or not explicitly described.

In the several figures, like reference numerals may be used for like elements having like functions even in different drawings. The embodiments described, and their detailed construction and elements, are merely provided to assist in a comprehensive understanding of the invention. Thus, it is apparent that the present invention can be carried out in a variety of ways, and does not require any of the specific features described herein. Also, well-known functions or constructions are not described in detail since they would obscure the invention with unnecessary detail.

### The Twitter Network (a Social Network Example)

The Twitter network is open to all people (followers) and allows them to access the website of a selected individual (the host) and read his or her message releases. A user may follow any number of hosts, those people who they find interesting for any of a variety of reasons. Accordingly, based on the attractiveness of the host, the network of host followers can encompass just a few people or range into the millions.

Presently, Twitter will accept any number of alias names. Accordingly, the host in some embodiments is given the same name as the product. For example, the Bookclipz Story for the book “Jaws” would be hosted by “Jaws”.

The host can release new information for his followers at any time, sometimes as frequently as three or four times a day. From a technical standpoint there are no real limits. However, the amount of information that is released to the network by any person at any one time, host or follower, is strictly limited to one hundred and forty characters (referred to as “tweets”), and every tweet message is tagged with the user name of the message writer. Further, any follower has the ability to post a tweet to the network for all to read and conversely any follower can receive direct messages from the host and any other person they follow. However the Twitter network makes no provision for any follower to send a direct tweet message to the host.

### Preparing the Advertisement

One embodiment of this invention starts with the chapters that encompass the text material of the work that is being prepared, or has been completed for sale. Using this material as a reference a writer creates the Advertisement which consists of a plurality of short messages (hereafter called “Units”) which follow the sequence of the storyline and chapter layout of the product being offered for sale. Staying consistent with the current practices of social networking, the content of the Units may be written using a first person format, focusing on the view point of the main character of the story, or from a host story moderator. In the Twitter Network application, Units will be limited to one hundred and forty characters each and meet the standards of a tweet. For other social and/or computer networks Units could encompass a character size larger than a tweet. For fictional works, each Unit advances the storyline of the work and in nonfiction works each Unit provides statements, facts or quotes from the book.

The Twitter network prefaces every Unit with the name of the host as the Unit message is processed into the Twitter network. For example, the name of the host might be Storyworkz, or Movie_Usher, or the title of the book. This “header” name is not part of the 140 character Twitter limit. Further, each Unit ends with a suitable URL website address that is created by the host, that is part of the 140 character limit established by Twitter, and connects the respondent back to a page designed to further the sales program setup by the host. In one embodiment this URL transmits the respondent back to the section of the host website enabling the reader to view other Units in the Bookclipz Story.

The aggregate of all Units forms a body of work referred to as a Social and/or Computer Network Story (or a Bookclipz Story) and has a separate copyright.

### Basic Elements of a Bookclipz Story:

A Bookclipz Story, a copyrighted work, transforms the story line and chapter flow of a finished published work into a plurality of Units which are released to the public in a time sequenced manner. In one embodiment, each Unit is prepared by a human editor using word processing software on a computer or by some other electronic text editing means. In an alternative embodiment, each Unit is prepared using an artificial-intelligence-based editing system programmed to select appropriate Bookclipz text from the original, generally unabridged source material.

A Unit may also be referred to equivalently as a Text Advertisement. Typically, the plurality of Units are created with an aim towards capturing some or all of the essential flow of the original source material, while still withholding significant details that a reader may be interested in learning more about.

The process of creating a Unit based on the original source material, and/or creating the plurality of units based on the original source material, is referred to herein as “parsing” the original source material.

The Units are stored in a digital format or other suitable format on a computer or similar storage device. The Units use the formats and standards established by the Internet and its network of affinity based organizations, including but not limited to social networks, associations, business and technical organizations, clubs, schools, hospitals, religious based affiliations, hobbyists and political movements.

In one embodiment, the Bookclipz Story has a word count limited to ten percent, or less, of the unabridged published work, and is divided into more than one hundred Units. For example, a Bookclipz Story that follows a fifty thousand word novel could consist of five thousand words divided into one hundred Units, with each Unit containing as many as fifty words. Using a release rate of one Unit per day the Bookclipz Story would be related to the public over a one hundred day period.

In an alternative embodiment, the Bookclipz Story may comprise a larger percentage of the total unabridged work. In an alternative embodiment, the Bookclipz Story may comprise one hundred or fewer Units.

### Unit Sequence

### Example A

### A Fiction Story Inside the Tweet Template

The following is an example of five Units (or tweets) which apply to the first few chapters of a book, “3 Days of the Condor”, where the story content is inserted inside the 140 character space template provided by Twitter. In this example the network follower is referenced back to the registrant/host (the storyteller) of the Twitter account (for example “Movie_Usher”) by the header name attached to the Unit. The end section, starting with “http”, contains a link to the host website.

1. I am trained to notice small details and it bothered me when I saw an open window in our office townhouse http://stwz.us/?i=118
2. Because of the open window I checked the immediate area and every other thing seemed normal, so I decided to enter http://stwz.us/?i=119
3. My spine began to tingle and my neck felt cold when I failed to get any response to my three door bell rings http://stwz.us/?i=120
4. A strange odor attacked my senses when I entered the downstairs area and found it empty of people http://stwz.us/?=121
5. My brain failed to register the fact that everybody was dead, brutally killed, as I moved from office to office http://stwz.us/?i=122

In some embodiments a different Bookclipz Story version for the same fiction work is created for use with other computer networks or for other sales applications, where the Unit size exceeds the 140 character limitation imposed by the Twitter Network. In this alternate case the same Unit construction format as shown above is maintained. However, the story component for each unit is expanded in size, up to 300 or 400 characters, ending with a suitable URL website address.

### Unit Sequence

### Example B

### A Non-Fiction Bookclipz Story

The following is an example of three Units which apply to a non-fiction book where the Unit content shown in Example A now applies to a theme, philosophy, fact, disclosure or point of view portrayed in the non-fiction work, and has not been constructed to advertise a made up, plot driven story. The basic construction of the Unit for this use is the same as in Example A. The content part of the Unit can be altered in size to meet, or exceed, the character limitations of Twitter, with its size dependent on its intended usage. Again, like in Example A above, the Unit ends with a suitable URL website address.

1. Friedman started to lay the foundations of his career when he crossed the Atlantic in July 1918 and reported for duty with Military Intelligence at General Pershing's headquarters in France.
2. When the war ended in November of 1918, Friedman picked up a huge amount of practical knowledge about the ways in which codes—and to some extent ciphers—are used in the field.
3. After World War I Friedman and his wife went to work for the US Army, in Washington D.C. where they toiled away at the comparatively routine business of developing low-level codes.

### Organizing for Advertising and Selling the Product

In an embodiment, the establishment of an Internet website, containing three main functions, is the precursor to conducting a social network advertising and sales program for any published work product. These functions are described accordingly:

1. Unit/Chapter Repository: A computer-based or other processor-associated storage area, such as a hard drive, optical drive, flash drive, or similar, containing all Units and all plain text equivalents of the entire unabridged published work. A data base of all previously released, and soon to be released, message units is maintained and network transfers are made to any computer designated by the Social and/or Computer Network or Store, or to any other source, at any time, by a computer to computer transfer.

2. Social and/or Computer Network Interface: A computer or other processor-based interface to register and maintain proper protocol with the different social networks and to maintain the periodic release schedule set by the website administrator for distributing Units for any given chapter.

These message units are released into various social and/or computer networks, including the Twitter Network, on a set periodic sequence which may be hourly, daily or weekly, and can be viewed freely and for no cost by any network member in order to create interest in the published work. The message units in some embodiments are released only on a website or on a website and through social networks. In some embodiments, all the message untis are shown to a user in one viewing, creating an experience akin to a move trailer or Cliff notes. For example, all units may be made available on a website for a user to view prior to making a purchasing decision.

3. Store: A computer or other processor-based device with the capability to process valid orders and sell selected chapters of the final published work to network members or to other designated persons by virtue of computer to computer downloads. Further, the store can sell the entire published work in a variety of other methods by initiating an order to a fulfillment center for the delivery of tangible products such as print or audio copies. The price for selling individual chapters may have a nominal charge (less than a dollar). The price for the entire published work follows normal commercial rates, properly adjusted to meet market conditions for the different product delivery formats.

In an embodiment, an Internet server is programmed with software modules to carry out these functions. In an alternative embodiment, a computer or other processor-based device is coupled to the Internet/other data distribution network, and is programmed with software to carry out these functions. In an alternative embodiment, a distributed processing system is coupled to the Internet or other data distribution network, and is programmed with software to carry out these functions.

### Collateral Applications

The same advertising products and methods described in this invention can be used apart from social networks. Their application to the websites of publishers, retail outlets and distributors of written story products (novels, biographies, diaries, memoirs, etc.) adds interesting dynamics and customer traffic flow to their websites and provide the potential purchaser with an opportunity to advance sample the published material without expending the money to purchase the product. The process is analogous to the displaying of short movie trailers to prospective audiences for the purpose of gaining their interest in paying to view a feature film.

Further, the creation of a Bookclipz Story provides the owner of a published work with an important sales tool in selling individual book chapters using computer to computer transfers. This should raise the overall income level to the published work owner because it creates what many believe to be a viable new market

The text advertisements (Bookclipz) in various embodiments are transmitted into many different types of computer networks, covering a wide variety of purposes, including, but not limited to social networks, i.e., for business organizations, religion, education, science and technology, government, etc.

A text advertisement (Bookclipz) does not have to be transmitted into computer networks, other than by users accessing the text advertisements on a website, to have value. By providing a user complete access, in one viewing, to all of the Units of a text advertisement to the entire Bookclipz Story of the type described herein on a website or elsewhere, the user is provided with added insight enabling him or her to make a more informed judgment on ordering the product.

Text advertisements (Bookclipz) for a fiction work in many embodiments serves a different market than for a non-fiction work. In some embodiments the fiction work serves a general purpose, wide interest, audience. Hence it is transmitted into every type of computer network that it can be, i.e, social, business, school, religious, government, etc. On the other hand the non-fiction works advertisements in some embodiments need to be transmitted to those computer networks that serve a niche, specialty market, i.e, chemists, accountants, baseball coaches, music teachers, architects, patent attorneys, etc. In some embodiments the construction of the header and trailer (the protocol) of the text advertisement (Bookclipz) is altered to fit into a special type of computer network.

The non-fiction text advertisement (Bookclipz) in some embodiments contains facts, quotes, or opinions that are extracted from the Work without any modification. In some embodiments these terms are condensed, edited or synopsized.

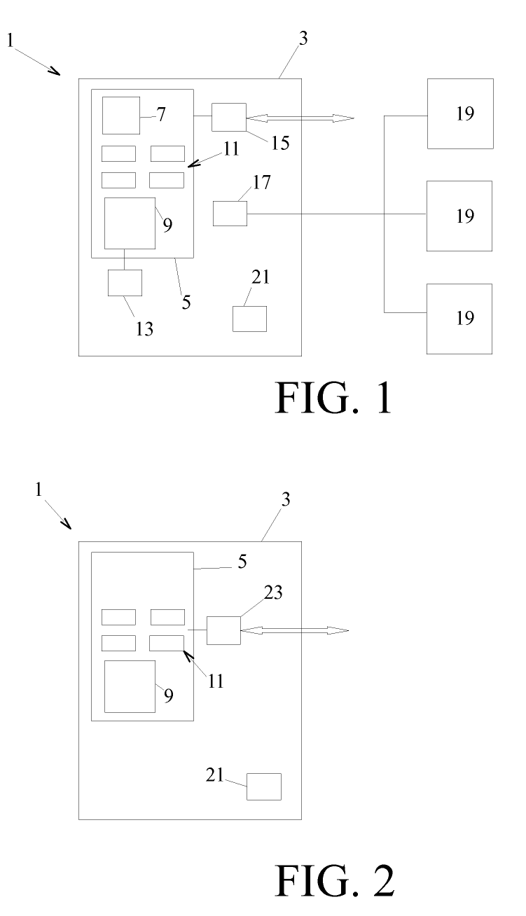

FIG. 1 is a diagram of a text advertisement system 1. One or more Internet servers 3 have a computer storage area 5 configured to store an unabridged text work 7, a plurality of units of text advertisements adapted from the unabridged text work 11, and a database of released units 9. Internet servers 3 are programmed with a database maintenance software module 13 that maintains the database of released units 9, a network transfer software module 15 that performs network transfers from the computer storage area, and a social network interface software module 17 that is coupled with social networks 19 and distributes text advertisements 11 by transmitting them over social networks 19. One or more of the servers is also programmed with an order processing and distribution software module 21 that processes orders and sells the unabridged text work by computer download or by initiating a fulfillment center order for delivery of tangible products.

FIG. 2 is a diagram of a text advertisement system 1. One or more Internet servers 3 have a computer storage area 5 containing an advertising story divided into message units 11 that parallels the storyline of an unabridged text work and a database 9 of released message units. One or more of the Internet servers 3 are programmed with a message unit release software module 23 that releases the message units 11 by transmitting them over the Internet or making them available for viewing or download over the Internet. One or more of the servers is also programmed with a store software module 21 that sells the unabridged text work or chapters of the unabridged text work over the Internet by download or initiating a fulfillment center order

The invention is not limited to the particular embodiments described above in detail. Those skilled in the art will recognize that other arrangements could be devised, for example, using units containing excerpts of movie dialog or descriptions of movie actions to advertise movies, or using units containing lyrics to advertise music, applying the method/system to the sale of any intellectual property items, fiction or non-fiction, such as magazines, audio tapes, patents, seminar reports, court proceedings, biographies, newspapers, etc., using Units having different appearances and with or without identification numbers, etc., and using a differently configured or arranged website or using a downloaded/installed computer software program instead of a website to implement some of the disclosed functions. The invention encompasses every possible combination of the various features of each embodiment disclosed. While the invention has been described with reference to specific embodiments, modifications and variations of the invention may be constructed without departing from the scope of the invention.

I claim:

1. A method, comprising:
storing on a processor-based device, a text advertisement based on an unabridged text,
electronically transmitting, using a processor-based device configured to transmit data over a computer network, the text advertisement over the computer network for viewing by consumers,
wherein the unabridged text is parsed to obtain and store a plurality of stand-alone text advertisements,
wherein each of the stand-alone text advertisements is formatted for transmission over the computer network, and
wherein each of the stand-alone text advertisements acts as a preview of the unabridged text by providing a piece of the story or information in the unabridged text.

2. The method of claim 1, wherein each text advertisement in the case of a fictional unabridged text work advances the story of the unabridged work, and in the case of a nonfiction unabridged text work contains a fact or quote from the unabridged text work.

3. The method of claim 1, wherein the transmitting the text advertisement comprises transmitting the text advertisement once a designated amount of time has passed since the last text advertisement was transmitted, until all of the text advertisements have been transmitted.

4. The method of claim 1, further comprising transmitting as part of a text advertisement a link to a website with more text advertisements or information about the unabridged text.

5. The method of claim 1, wherein the electronically transmitting the text advertisement comprises transmitting the text advertisement over social networks in the format required by the social networks.

6. The method of claim 1, wherein the electronically transmitting the text advertisement comprises transmitting the abbreviated text advertisement over at least one of:
multiple social networks, and
a website interface.

7. The method of claim 1, wherein the text advertisement for the unabridged text parallels the unabridged text and follows its storyline and chapter layout.

8. The method of claim 1, wherein the transmitting the text advertisement comprises making the text advertisement available on a website for viewing over the Internet.

9. A system, comprising:
one or more Internet servers comprising a computer storage area configured to store:
an unabridged text work,
a plurality of units of text advertisements adapted from the unabridged text work, and
a database of released units;
a database maintenance software module that maintains the database of released units;
a network transfer software module that performs network transfers from the computer storage area; and
a social network interface software module which is coupled with social networks and distributes text advertisements by transmitting them over social networks,
wherein one or more of the Internet servers are programmed with the database maintenance software module, network transfer software module, and social network interface software module, and
wherein each text advertisement is stand-alone and acts as a preview of the unabridged text work by providing a piece of the story or information in the work.

10. The system of claim 9, further comprising an order processing and distribution software module that processes orders for chapters of the unabridged text work and sells the unabridged text work by at least one of:
computer download, or
by initiating a fulfillment center order for delivery of tangible products.

11. The system of claim 9, wherein a text advertisement in the case of a fictional unabridged text work advances the story of the unabridged work, and in the case of a nonfiction unabridged text work contains a fact or quote from the unabridged text work.

12. The system of claim 9, wherein the social network interface software module maintains a release schedule for distributing text advertisements by transmitting the advertisements over social networks at designated times or time intervals.

13. The system of claim 9, wherein the social network interface software module transmits the text advertisements in sequence, such that each text advertisements that is transmitted provides a piece of the story or information in the work from further in the work than the text advertisement transmitted before it.

14. The system of claim 9, wherein the database of released text advertisements is made accessible over the Internet for access by any Internet user at any time.

15. The system of claim 9, wherein the text advertisement for the unabridged text work parallels the unabridged text work and follows its storyline and chapter layout.

16. The system of claim 9, wherein each text advertisement comprises an indication of the chapter, or paragraph, or sentence, or word, to which the unit corresponds.

17. The system of claim 9, wherein each text advertisement is limited to a designated length limit associated with a designated social network message protocol.

18. The system of claim 9, wherein the social network interface software module automatically places each text advertisement in a format associated with a designated social network before transmitting it over the designated social network.

19. A system, comprising:
one or more Internet servers comprising a computer storage area containing an advertising story divided into message units that parallels the storyline of an unabridged text work and a database of released message units, and
a message unit release software module that releases the message units by transmitting them over the Internet or making them available for viewing or download over the Internet,
wherein one or more of the Internet servers is programmed with the message unit release software module.

20. The system of claim 19, wherein the message units are short, plain text messages.

21. The system of claim 19, wherein the message units follow the chapter layout of the unabridged text work.

22. The system of claim 19, wherein the database of released message units is accessible to all Internet users.

23. The system of claim 19, wherein the message unit release software module releases the message units one at a time with a designated time between each release.

24. The system of claim 19, further comprising a store software module that sells the unabridged text work or chapters of the unabridged text work over the Internet by download or initiating a fulfillment center order, wherein one or more of the Internet servers is programmed with the store software module.

25. A method, comprising:
transmitting a text advertisement for viewing by consumers using a processor-based device programmed to facilitate text transmission,
creating a plurality of text advertisements paralleling an unabridged text and following its storyline and chapter layout, each text advertisement of the plurality comprising a stand-alone text message unit, and
storing the plurality of text advertisements on a processor-based device,
wherein each text advertisement acts as a preview of the unabridged text by providing a piece of the story or information in the unabridged text.

26. The method of claim 1, wherein the electronically transmitting the text advertisement comprises transmitting the text advertisement over an organization's network in the format required by the organization's network.

27. The method of claim 1, wherein the unabridged text is a nonfiction text related to a subject matter category, wherein the electronically transmitting the text advertisement comprises transmitting the text advertisement over an organization's network, wherein the organization relates to the subject matter category.

28. The method of claim 8, wherein making the text advertisement available on a website for viewing over the Internet comprises making all the stand-alone text advertisements available simultaneously on the website for a user to read in a single viewing.

29. The system of claim 19, wherein the message unit release software module releases all the message units simultaneously on a website.
